(19) United States
(12) Patent Application Publication
(10) Pub. No.: US 2021/0213641 A1
(43) Pub. Date: Jul. 15, 2021

(54) APPARATUS FOR PRODUCING FOAMED BUILDING MATERIALS

(71) Applicant: Holger Gawryck, Pfronten (DE)

(72) Inventor: Holger Gawryck, Pfronten (DE)

(21) Appl. No.: 17/270,546

(22) PCT Filed: Aug. 22, 2019
(86) PCT No.: PCT/EP2019/072442

§ 371 Date: Feb. 23, 2021

(30) Foreign Application Priority Data
Aug. 23, 2018 (DE) 10 2018 214 262.9

(51) Int. Cl. B28C 5/38; B28C 7/04; B28C 7/02; B28C 9/00; B01F 3/04; B01F 15/00; B01F 15/04

(52) U.S. Cl. CPC B28C 5/388; B28C 7/0418; B28C 7/024; B28C 9/002; B01F 2215/0047; B01F 15/00285; B01F 15/0408; B01F 15/00175; B01F 15/00162; B01F 3/04992

(57) ABSTRACT

The invention relates to an apparatus (110) for producing foamed building materials, comprising a gas supply unit (112), a suspension supply unit (150-156), and a mixing chamber (118), the apparatus (110) further comprising a control and/or regulating unit (136) which has means (116, 124, 130, 134, 146,) for supplying values of a plurality of input parameters, based on which at least a temperature of the dispersion and an air pressure in an environment of the apparatus (110) can be inferred, the control and/or regulating unit (136) being further configured to influence at least one output parameter, by means of which the ratio of the volumes and/or masses and/or densities of gas and suspension supplied per unit of time can be adjusted. The invention further relates to a corresponding method.

The present invention relates to an apparatus for producing foamed building materials, comprising a gas supply unit which is configured to supply gas to the apparatus, a suspension supply unit which is configured to supply suspension to the apparatus, and a mixing chamber which is configured to mix the gas supplied by the gas supply unit and the suspension supplied by the suspension supply unit to form a dispersion.

The inventor of the present invention has been developing and marketing apparatuses for producing foamed building materials for many years. It has been shown, however, that a system which, for example, is adjusted to customer-specific default values at the inventor's premises, delivers the desired result there but may deliver a result at a customer's premises located far away which deviates from this without the values entered having been changed.

A similar problem may occur at one and the same installation site of the apparatus, for example if there is a change in the ambient conditions in a production hall and/or in the storage conditions of the components to be mixed.

It is therefore the object of the present invention to provide an apparatus for producing foamed building materials which can deliver a constant output result despite changing ambient and/or input conditions.

This object is achieved by an apparatus of the type referred to at the outset, the apparatus further comprising a control and/or regulating unit which has means for supplying values from a plurality of input parameters, based on which at least a temperature of the dispersion and an air pressure in an environment of the apparatus can be inferred, the control and/or regulating unit being further configured, based on the values of the input parameters supplied to it, to influence at least one output parameter, by means of which the ratio of the volumes and/or masses and/or densities of gas and suspension supplied per unit of time can be adjusted.

On the one hand, the inventor of the present invention realized that the result of the apparatus for producing foamed building materials depends significantly on the volume flow rates and rather subordinately on the mass flow rates. Now, in order to guarantee a uniform volume flow rate of each component during changing ambient conditions or input conditions of the components to be mixed, it is necessary to detect and compensate the respective effects of a change in ambient conditions or input conditions for operation of the apparatus for producing foamed building materials.

However, alternatively or in addition to adjusting the volumes supplied, adjusting the masses and/or densities of gas and suspension supplied can also result in the desired effect, for example by using determined target volumes which are converted into target values for a mass flow rate to be adjusted or target values of the density.

On the other hand, the inventor of the present invention realized that measuring, for example, the temperature and air pressure of the components to be mixed does not, by itself, maintain the production result in the presence of changing ambient conditions or input conditions. The inventor realized that, during mixing of the components in the mixing chamber, an input energy may be introduced into the component mixture (also referred to as “dispersion”) which may also be dependent on the ambient conditions or input conditions and which has not been considered in apparatuses known in prior art.

Only a combination of detecting an air pressure, which in particular has an effect on a gas before and after mixing, together with detecting a temperature of the dispersion makes it possible to reliably compensate changing ambient conditions and/or input conditions of the components to be mixed.

This invention is, of course, applicable to both apparatuses operating continuously and non-continuously, for example in cycles. In these apparatuses, for example, gas metering may be continuous or non-continuous.

“Mixing” in the mixing chamber may be carried out, for example, by injection, agitation, shaking, pouring, folding in, and/or gas dissolution.

Advantageously, the means may be configured to detect a temperature of the dispersion in a region in which the dispersion leaves the mixing chamber or/and in which the dispersion leaves a conveying unit associated with the mixing chamber. It should be mentioned directly at this point that the expression “in a region” is intended to mean that the temperature of the dispersion directly after mixing of the components to be mixed, i.e. still in the mixing chamber, can be detected up to an outlet of the mixing chamber; detection both still inside the mixing chamber and also outside the mixing chamber being conceivable here. In the event that the outlet of the mixing chamber is connected to a conveying unit, such as a pipe or hose for example, it is also possible for detection not to be performed until at an end of this conveying unit; detection both still inside the mixing chamber and also outside the mixing chamber again being conceivable here.

In a development of the present invention, the apparatus further comprises a foam generating unit which is upstream of the mixing chamber and which is configured to mix the gas supplied by the gas supply unit with a liquid, resulting in a foam. In the mixing chamber, the foam can then be mixed with the suspension to be mixed, resulting in a foamed dispersion. The foam may be based on at least one from enzymes, tensides or proteins. By using a foam generating unit, it can be ensured that thorough mixing of the gas and suspension is carried out evenly and with a predefined size of the gas inclusions in the dispersion.

The mixing chamber may be sealed with respect to an external environment of the mixing chamber. “Sealing” in this sense means that only the components to be mixed, for example suspension and gas or foam, as mentioned above, enter the mixing chamber. In this way, it is possible to prevent ambient air from flowing into the mixing chamber as is the case with open chambers. This can ensure that processes taking place in the mixing chamber can proceed unaffected by an environment of the mixing chamber.

For example, the mixing chamber may be constructed at a point where piping elements which convey the suspension or the gas/foam are brought together.

A mixing element, which is arranged in the mixing chamber and is configured to mix the components to be mixed, may be adjusted in this case such that it leaves the material flow of the two components and/or the dispersion unchanged, i.e. it does not affect their volume flow rate.

Advantageously, the means for supplying values of a plurality of parameters comprise at least one temperature sensor and/or one air pressure sensor.

The provision of sensors can automate detection of a temperature and/or an air pressure. For example, if previously a user of the apparatus for producing foamed building materials had to forward values manually to the control and/or regulating unit, by using a keyboard for example, based on which values at least a temperature of the dispersion and/or an air pressure in the environment of the apparatus could be determined, the control and/or regulating unit can now receive these values directly from the sensors. In addition, the provision of a temperature sensor and/or an air pressure sensor can enable direct detection of a temperature and/or an air pressure, instead of using values based on which a temperature and/or an air pressure can be inferred.

The apparatus may further comprise at least one further temperature sensor which is configured to detect a temperature of the suspension supplied by the suspension supply unit and/or of the gas supplied by the gas supply unit and/or of the foam introduced into the mixing chamber by the foam generating unit. By detecting a temperature of the respective basic media which are to be mixed in the mixing chamber, i.e. the suspension and the gas or foam, it may be possible to specify a respective target temperature and, using appropriate equipment, to control the temperature of these components before they enter the mixing chamber, i.e. to heat or cool them, so that the basic media entering the mixing chamber are already at the predefined temperature.

In a development of the present invention, the apparatus may also comprise a memory unit which is operatively coupled to the control and/or regulating unit and which is configured to output at least one value from a predetermined dispersion temperature and/or a predetermined gas temperature and/or a predetermined suspension temperature and/or a predetermined air pressure to the control and/or regulating unit. The control and/or regulating unit can thus be provided with reference values, based on which the control and/or regulating unit can automatically control the apparatus, for example the volume flow rate of one of the components to be mixed.

In addition, the apparatus may include at least one pressure sensor which is configured to detect a system pressure during an input of gas and/or a pressure in a discharge space of the foamed dispersion. “System pressure during an input of gas” means the pressure which prevails in the mixing chamber when the suspension is mixed with the gas or the foam. “Pressure in a discharge space of the foamed dispersion” means a space into which the foamed dispersion enters on leaving the apparatus for producing foamed building materials, for example to harden there. The discharge space may be closed off or sealable in respect of an environment which surrounds the discharge space or may be in fluid communication with the environment.

The apparatus may further comprise at least one mass flow sensor, in particular a calorimetric flow measuring device which is configured to detect a mass flow rate of the gas supplied and/or a mass flow rate of the dispersion and/or a mass flow rate of the suspension and/or a mass flow rate of the liquid supplied and/or a mass flow rate of the foam supplied. A volume flow rate of a relevant medium may also be determined, based on a detected mass flow rate, for example in combination with a detected temperature and/or a known gas constant, so that there is no need for direct detection of a volume flow rate. The detection of a mass flow rate and the use of elements suitable for this purpose may have advantages with reference to an arrangement or an installation space of these elements in the apparatus for producing foamed building materials or with reference to costs.

Alternatively or in addition, the apparatus may further comprise at least one volume flow sensor which is configured to detect a volume flow rate of the gas supplied and/or a volume flow rate of the dispersion and/or a volume flow rate of the suspension and/or a volume flow rate of the liquid supplied and/or a volume flow rate of the foam supplied. In this way, a particular volume flow rate can be detected directly without having to determine it based on at least one other property of the respective medium.

In this case, the volume flow sensor may also comprise one of an impeller sensor, a vortex flow measuring device, a float-type flow measuring device and a calorimetric flow measuring device.

In a further aspect, the present invention relates to a method for producing foamed building materials, comprising the steps:

Providing a suspension using a suspension supply unit,

Providing a gas using a gas supply unit, and

Mixing the suspension and the gas to form a dispersion in a mixing chamber, characterized in that the method further comprises the steps:

Detecting a temperature of the dispersion

Detecting an ambient air pressure,

Transmitting the detected temperature of the dispersion and of the detected ambient air pressure to a control and/or regulating unit,

Adjusting of at least one from a volume flow rate of the gas, a mass of the gas, a temperature of the gas, a pressure of the gas, a volume flow rate of the suspension, a mass (m) of the suspension and a density of the suspension by the control and/or regulating unit, based on the detected temperature of the dispersion and the detected ambient air pressure.

It should be noted at this point that all features and advantages of the apparatus for producing foamed building materials described above are similarly applicable to the method for producing foamed building materials and vice versa.

The method may also comprise the following steps:

Providing at least one reference value from a memory unit to the control and/or regulating unit,

the reference value indicating at least one from a temperature and/or a pressure and/or a volume flow rate of the dispersion and/or a temperature and/or a pressure and/or a volume flow rate of the gas and/or a temperature and/or a pressure and/or a volume flow rate of the suspension,

Comparing a currently detected value with an associated reference value, and

Adjusting a device and/or unit and/or apparatus associated with a particular value in such a manner that a current value approximates to the associated reference value.

As already mentioned above with regard to the apparatus for producing foamed building materials, providing a particular reference value can make it possible to automatically control regulation of the production process, based on predefined parameters determined by the particular reference value. Storage of parameters as such a reference value or a plurality of such reference values may similarly take place automatically, for example, in that a method or an apparatus for producing foamed building materials is operated for a predefined period without adjusting corresponding input values. Furthermore, the last input parameters which were adjusted before the apparatus was switched off can be stored as particular reference values.

Of course, a particular reference value and/or a particular current value may be standardized to predefined normal conditions before the step of comparing. For example, to be able to compare a value which was determined during first ambient conditions or input conditions with a value which was determined during second ambient conditions or input conditions that differ from the first, it may be necessary to standardize the first value and/or the second value to predefined normal conditions. In this case, it is conceivable that either conditions defining the first value or conditions defining the second value or conditions different from the conditions defining the first or the second value are used as reference for these normal conditions. In particular, the normal conditions comprise a predefined temperature and a predefined absolute air pressure to which the particular values are to be standardized.

It has become common practice among skilled persons in general that a volume of the standard conditions is given in normal liters NL at 0° C. and an absolute air pressure of 1013.25 mbar. This also corresponds, for example, to DIN 1343.

As is generally known, a change in temperature or a change in air pressure has a much greater effect on the volume of gaseous media than on the volume of liquid media. For this reason, the above-mentioned standard conditions at 0° C. and an absolute air pressure of 1013.25 mbar are to be applied in particular to gaseous media. For liquids, both standardization to 0° C. and standardization to 20° C. have become established among skilled persons in general.

The present invention is described below in greater detail based on embodiments with reference to the associated drawings which show:

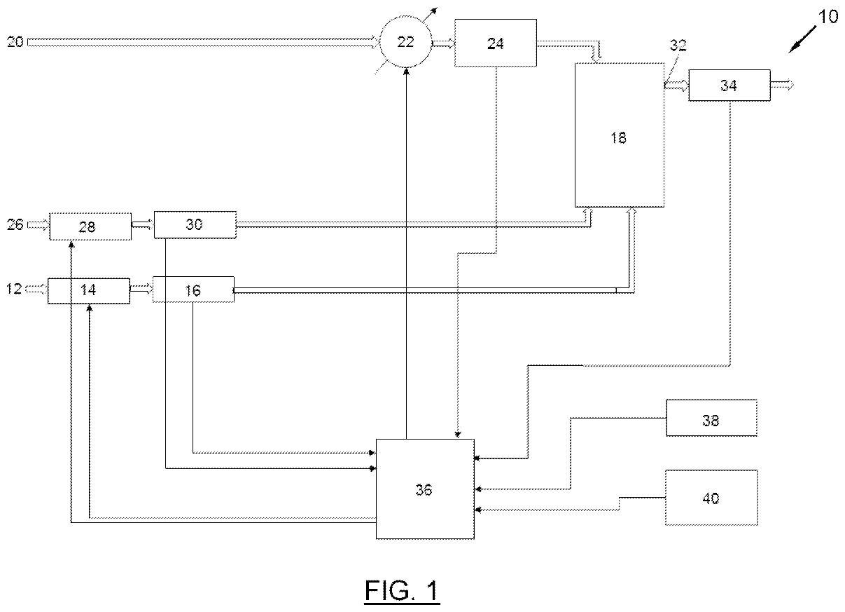

FIG. 1 a schematic construction of a first embodiment of an apparatus for producing foamed building materials according to the invention;

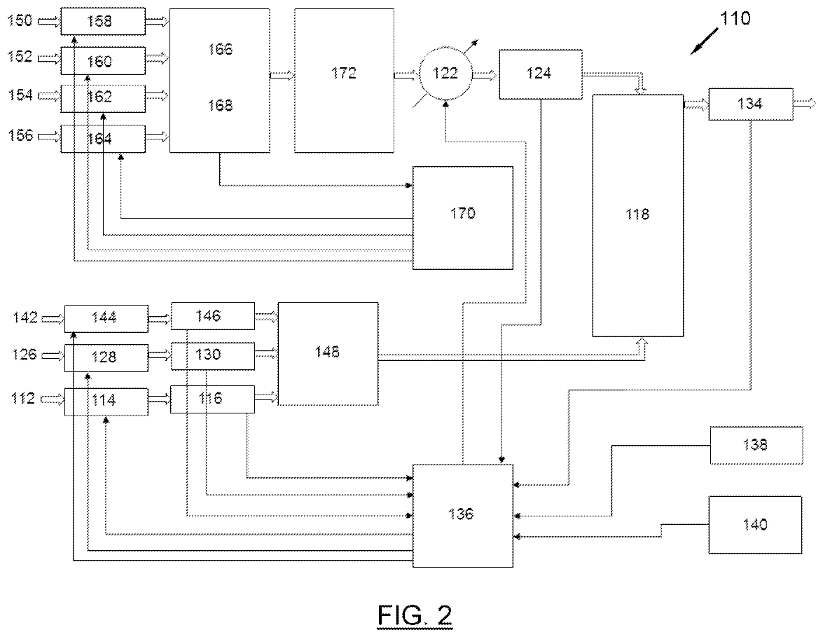

FIG. 2 a schematic construction of a second embodiment of an apparatus for producing foamed building materials according to the invention.

The apparatus for producing foamed building materials represented schematically in FIG. 1 is generally denoted by the reference number 10.

A gas, such as compressed air for example, is fed into the apparatus 10 at a gas inlet 12. Downstream of the gas inlet 12 is a metering device 14, for example a valve, via which the amount of gas supplied can be regulated. The gas then flows through a measuring device 16 which is configured here to detect a volume flow rate Q of the gas. Of course, the flow could also pass first through the measuring device 16 and then through the metering device 14. Subsequently, the gas arrives in a mixing chamber 18.

A suspension is fed into the apparatus 10 at a suspension inlet 20 of the apparatus 10. In the embodiment shown in FIG. 1, the suspension is conveyed into the apparatus 10 using a metering pump 22. Downstream of the metering pump 22, the suspension is conveyed into the mixing chamber 18 via a measuring device 24 which is configured to detect a volume flow rate Q of the suspension and optionally a density p of the suspension. Alternatively, the measuring device 24 here could also be arranged upstream of the metering pump 22.

In the embodiment shown here, the apparatus 10 further comprises a foaming agent inlet 26 at which a foaming agent is fed into the apparatus 10. The foaming agent also first passes through a metering device 28, such as a control valve for example, and then a measuring device 30 which is configured to detect a volume flow rate Q of the foaming agent.

Subsequently, the foaming agent is also fed into the mixing chamber 18.

A mixing element, not shown, which can be configured both to produce a foam from the foaming agent and the gas and also to produce a dispersion from foaming agent/gas or foam and suspension, is arranged in the mixing chamber 18. The dispersion leaves the mixing chamber 18 at an outlet 32 of the mixing chamber 18, a temperature measuring device 34 being configured to detect a temperature T of the dispersion leaving the mixing chamber 18. Downstream of the temperature measuring device 34, the dispersion, which is formed, for example, as a mineral foam, is conveyed further depending on the customer-specific arrangement of the apparatus 10, the dispersion, of course, similarly having a density p and a volume flow rate Q.

The measured values detected by the measuring devices 16, 24, 30, 34 are read out on a control and/or regulating unit 36. Furthermore, an air pressure P, which is present in an environment of the apparatus 10, is detected by an air pressure measuring device 38 and read out on the control and/or regulating unit 36. The control and/or regulating unit 36 can then, for example based on reference values, i.e. for example target values relating to the density p of the dispersion, the density p of the foam, a volume flow rate Q of the dispersion and/or a concentration C of the foaming agent, which is measured, for example, in percent or in kilograms per cubic meter, carry out control of a particular metering device 14, 22, 28 in order to approximate an actual result to a target result. In this case, the reference values may be stored in a memory unit 40 which is operatively connected to the control and/or regulating unit 36.

Using the apparatus 10 shown in FIG. 1, it is possible, regardless of an air pressure prevailing in an environment of apparatus 10 or of parameters of the components to be mixed, to produce a dispersion which has a predetermined density p and a predetermined volume flow rate Q, based on the regulation according to the invention.

FIG. 2 shows a second embodiment of an apparatus according to the invention which is generally provided with the reference number 110. The apparatus 110 is based substantially on the apparatus 10 according to FIG. 1. For this reason, components of apparatus 110 which are similar to the apparatus 10 are provided with the same reference numbers but increased by 100. At this point, it should be mentioned explicitly that all features and advantages of the apparatus 10 are also applicable to the apparatus 110 and vice versa. Accordingly, only the differences between the apparatus 110 and the apparatus 10 are described below.

In addition to the elements known from the apparatus 10, the apparatus 110 further comprises a water inlet 142 via which water is fed into the apparatus 110. The water fed into the apparatus 110 flows through a corresponding metering device 144 and a measuring device 146 which is configured to detect a volume flow rate Q of the water. The water, together with the foaming agent and the gas (see description for the apparatus 10), enters a foam generator 148 in which the water, the foaming agent and the gas are mixed to form a foam.

The foam generated in the foam generator 148 is subsequently fed into a mixing chamber 118.

Instead of the suspension inlet 20 of the apparatus 10, the apparatus 110 has a mixing water inlet 150, a binder inlet 152, an aggregate inlet 154 and an additive inlet 156 that are separate from each other. Subsequently, the mixing water fed into the apparatus 110 via the mixing water inlet 150 flows through a metering device for mixing water 158, the binder fed into the apparatus 110 via the binder inlet 152 flows through a metering device for binder 160, the aggregates fed into the apparatus 110 via the aggregate inlet 154 pass through a metering device for aggregates 162 and the additives fed into the apparatus 110 via the additive inlet 156 pass through a metering device for additives 164.

The mixing water, the binder, the aggregates and the additives then enter a suspension mixer 166 which is configured to produce a suspension from the mixing water, the binder, the aggregates and the additives. In this case, the apparatus or the suspension mixer 166 may have at least one weighing device 168 which is configured to detect a mass m of the mixing water and/or a mass m of the binder and/or a mass m of the aggregates and/or a mass m of the additives. The weighing device 168 can pass the detected values to a control and/or regulating unit 170 of the suspension mixer 166 which has available, for example, target values for the mass m of the mixing water and/or the mass m of the binder and/or the mass m of the aggregates and/or the mass m of the additives, based on which the metering devices 158, 160, 162, 164 can be controlled in order to adjust detected actual values to the stored target values.

The suspension produced in the suspension mixer 166 enters a buffer tank 172 in which the suspension produced can be intermediately stored.

Via a metering pump 122, as known from the apparatus 10, the suspension is then conveyed into the mixing chamber 118 via a measuring device 124, also known from the apparatus 10. In the mixing chamber 118, the foam is mixed to form a dispersion with the suspension in a similar manner to the description with reference to FIG. 1, its temperature T being detected in a temperature measuring device 134.

In contrast to the control and/or regulating unit 36 of the apparatus 10, a control and/or regulating unit 136 of the apparatus 110 additionally has a volume flow rate Q of the water fed into the apparatus 110 via the water inlet 142 as an input variable. Accordingly, the control and/or regulating unit 136 is also configured to control the metering device 144 for the water to be fed into the apparatus 110 and thus to control the amount of water fed into the apparatus 110.

1. An apparatus for production of foamed building materials, comprising:
a gas supply unit configured to supply gas to the apparatus;
a suspension supply unit configured to supply suspension to the apparatus; and
a mixing chamber configured to mix the gas supplied by the gas supply unit and the suspension supplied by the suspension supply unit to form a dispersion;
a control unit including means for supplying values of a plurality of input parameters used to infer at least a temperature of the dispersion and an air pressure in an environment of the apparatus, can be inferred, wherein the control unit is further configured, based on the values of the input parameters supplied to it, to influence at least one output parameter to adjust the ratio of one or more of the volumes, masses, or densities of the gas and the suspension supplied per unit of time.

2. The apparatus of claim 1,
wherein the means for supplying values of the plurality of input parameters are configured to detect the temperature of the dispersion in one or more of a region in which the dispersion leaves the mixing chamber or a region in which the dispersion leaves a conveying unit associated with the mixing chamber.

3. The apparatus of claim 1, further comprising a foam generating unit upstream of the mixing chamber, wherein the foam generating unit is configured to mix the gas supplied by the gas supply unit with a liquid, resulting in a foam.

4. The apparatus of claim 1, wherein the mixing chamber is sealed with respect to an external environment of the mixing chamber.

5. The apparatus of claim 1, wherein the means for supplying values of the plurality of parameters comprise one or more of a temperature sensor or an air pressure sensor.

6. The apparatus of claim 1, further comprising at least one further temperature sensor which is configured to detect at least one of (i) a temperature of the suspension supplied by the suspension supply unit, (ii) a temperature of the gas supplied by the gas supply unit, or (iii) a temperature of the foam introduced into the mixing chamber by the foam generating unit.

7. The apparatus of claim 1, further comprising a memory unit operatively coupled to the control unit and configured to output at least one value to the control unit including one or more of a predetermined dispersion temperature, a predetermined gas temperature, a predetermined suspension temperature, or a predetermined air pressure.

8. The apparatus of claim 1, further comprising one or more pressure sensors configured to detect one or more of a system pressure during a gas input or a pressure in a discharge space of the foamed dispersion.

9. The apparatus of claim 1, further comprising at least one mass flow sensor comprising a calorimetric flow measuring device configured to detect at least one of (i) a mass flow rate of the gas supplied, (ii) a mass flow rate of the dispersion, (iii) a mass flow rate of the suspension, (iv) a mass flow rate of the liquid supplied, (v) a mass flow rate of the foam supplied.

10. The apparatus of claim 1, further comprising at least one volume flow sensor configured to detect at least one of (i) a volume flow rate of the gas supplied, (ii) a volume flow rate of the dispersion, (iii) a volume flow rate of the suspension, (iv) or a volume flow rate of the liquid supplied, or (v) a volume flow rate of the foam supplied.

11. The apparatus of claim 10, wherein the at least one volume flow sensor comprises one of an impeller sensor, a vortex flow measuring device, a float-type flow measuring device, or a calorimetric flow measuring device.

12. A method for producing foamed building materials, comprising:
providing a suspension using a suspension supply unit;
providing a gas using a gas supply unit;
mixing the suspension and the gas to a dispersion in a mixing chamber;
detecting a temperature of the dispersion;
detecting an ambient air pressure;
transmitting the detected temperature of the dispersion and the detected ambient air pressure to a control unit;
adjusting, by a control unit and based on the detected temperature of the dispersion and the detected ambient air pressure, at least one of (i) from a volume flow rate of the gas, (ii) a mass of the gas, (iii) a temperature of the gas, (iv) a pressure of the gas, (v) a volume flow rate of the suspension, (vi) a mass of the suspension, or (vii) a density of the suspension.

13. The method of claim 12, further comprising:
providing at least one reference value from a memory unit to the control unit, wherein the at least one reference value indicates at least one of a temperature of the dispersion, a pressure of the dispersion, or a volume flow rate of the dispersion;
comparing a detected value with an associated one of the at least one reference value, and
adjusting one or more of a device, a unit, or an apparatus associated with a particular value in such a manner that the detected value approximates to the associated reference value.

14. The method of claim 12, wherein, at a time before the comparing, one or more of a particular reference value or a particular detected value are standardized to predefined normal conditions.

15. The method of claim 14, wherein a volume of the standard conditions is given in normal liters (NL) at zero degrees Celsius (0° C.) and at an absolute air pressure of 1013.25 millibars (mbar).

16. The apparatus of 1, further comprising at least one further temperature sensor which is configured to detect a temperature of the gas supplied by the gas supply unit.

17. The method of claim 12, further comprising:
providing at least one reference value from a memory unit to the control, wherein the reference value indicates one or more of a temperature of the gas, a pressure of the gas, or a volume flow rate of the gas; and
comparing a detected value with an associated reference value, and
adjusting one or more of a device, a unit, or an apparatus associated with a particular value in such a manner that the detected value approximates to the associated reference value.

18. The method of claim 12, further comprising:
providing at least one reference value from a memory unit to the control, wherein the reference value indicates one or more of a temperature of the suspension, a pressure of the suspension, or a volume flow rate of the suspension; and
comparing a detected value with an associated reference value, and
adjusting one or more of a device, a unit, or an apparatus associated with a particular value in such a manner that the detected value approximates to the associated reference value.
